(19) United States
(12) Patent Application Publication
(10) Pub. No.: US 2006/0120406 A1
(43) Pub. Date: Jun. 8, 2006

(54) Internet A/V data imaging results & transmission rate improvement methodology

(76) Inventor: Chao-Hung Wu, Hsin-Tien City (TW)

Correspondence Address: LEONG C LEI, PMB # 1008, 1867 YGNACIO VALLEY ROAD, WALNUT CREEK, CA, 94598, US

(21) Appl. No.: 11/002,092

(22) Filed: Dec. 3, 2004

(51) Int. Cl. H04J 1/02; H04J 3/00

(52) U.S. Cl. 370/493; 370/521

(57) ABSTRACT

A methodology to improve Internet A/V data imaging results and transmission rate includes a high-fold A/V data compression means (Mpeg4-3) to compress the A/V data in a size of 1/400 of the original size; only more than 20K up to 30K band width being required for transmission in Internet; and software operation from a reduction means of software simulation compensation being introduced in decompression upon data being received/retrieved for the picture quality after decompression to approximate that of the original data by compensation of distortions including snow, square, and interference.

### BACKGROUND OF THE INVENTION

(a) Technical Field of the Invention

The present invention is related to a methodology to improve Internet A/V data imaging results and transmission rate, and more particularly, to a technology that is applied in Internet in the configuration of ADSL and modem for full screen playback/dialog free of delayed, blur, or intermittent image.

(b) Description of the Prior Art

Compression and decompression technologies are a must to have AV communication over Internet. The flow process is as illustrated in FIG. 1 of the accompanying drawings. First a PC CAMARA provided at one end of the network retrieves AV data (11), then compressed into data packet (12) and transmitted to Internet (13); the compressed data packet is received (15) and decompressed (16) at the other end of the network, and finally a monitor plays back the AV. AV compression technology available today comes into types, respectively, HW compression/decompression and SW compression/decompression. The formal is not an ideal option for PC user since he has to purchase expensive additional HW and go through many complicated setup and installation. The latter appears to be economic and efficient option since no additional HW setup and installation are required; instead, it entirely leaves compression and decompression to the CPU in the PC. However, achievement of perfect compression ratio, compression and decompression without distortion significantly varies depending on the individual PC user.

Currently, the option of SW compression and decompression is very popular technology and approach in the market However, Mpeg4-2 or Mpeg4-1 (with compression result approximately at 200×, or 50˜100× respectively), and all the second half of SW compression technologies at its best wind up at decompression. The problem is that the better the compression technology and higher the compression multiple are, the worse the result of decompression gets due to that more damage done to the data as the compression multiple is higher after the reduction. So far there is the absence of any service provider capable of achieving real time AV results with strict SW facilities to warrant well-facilitated AV communication over Internet with limited bandwidth. Video function results from Net-meeting, Yahoo message of MSN are far less from being perfect. Delayed, blurred or intermittent conditions remains a very serious problem. Furthermore, it takes at least the bandwidth of 300K˜400K or above, i.e., ADSL 512K/512K is required to manage to run the application SW in one-on-one connection over those networks. Since ADSL is not guaranteed for the bandwidth and the 300K˜400K or above is the minimum, the video results are never reliable.

### SUMMARY OF THE INVENTION

The primary purpose of the present invention is to provide a high multiple compression technology to achieve smooth AV transmission over the Internet and allow full-screen playback/dialog that takes only 20˜30K bandwidth to run.

Another purpose of the present invention is to provide a high multiple compression technology that warrants over 90% display results of the original data after reduction from the network transmission while improving AV data compression ratio.

To achieve the purposes, the present invention provides a methodology to improve AV data imaging results and transmission rate over Internet. Firstly, a high multiple AV data compression means (Mpeg4-3) is used to compress the AV data to 1/400 of its original size for the decompressed AV data to be transmitted through a bandwidth only of 20˜30K. Once the decompressed data are received or retrieved, an AV data decompression/compensation means reduces the data acquired for full-screen, real time playback. Wherein, a reduction means of SW simulation compensation is introduced in the course of decompression to compensate distortion, e.g., snow, square, or interference, resulted from the decompression for the quality of the picture after reduction to approximate that of the original AV data, DVD or VDC.

No other software than the methodology disclosed in the present invention in the world up to now is capable of transmitting image and sound over Internet in such a limited bandwidth of 20K˜30K for practically real time and smooth display. The methodology disclosed in the present invention achieves the purposes even the transmission is done with a dial Modem (56K).

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a block chart of the transmission of network AV data of the prior art.

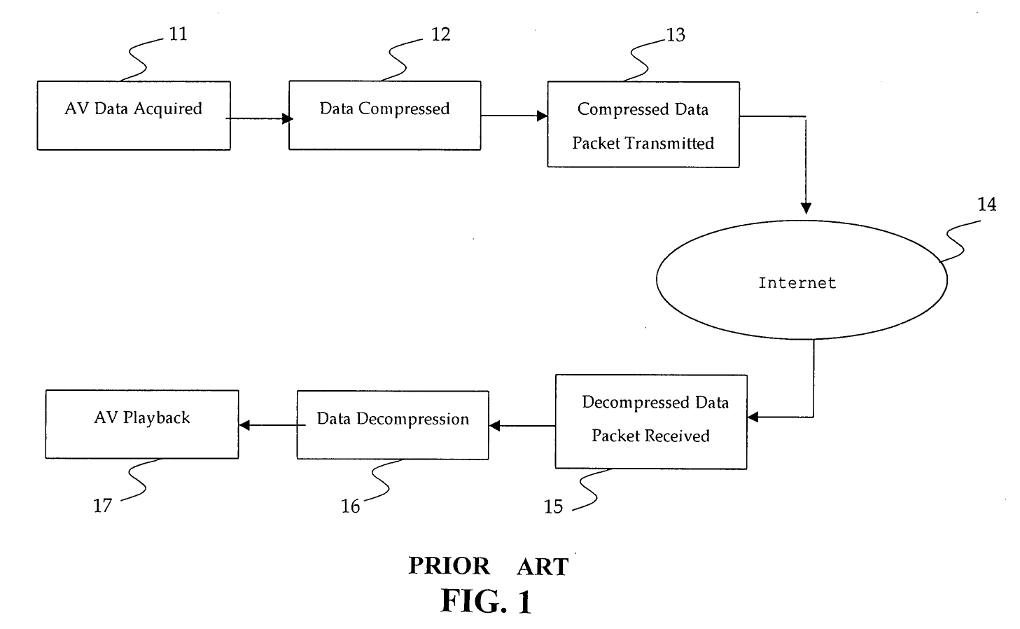

FIG. 2 is a block chart of the transmission of network AV data of the present invention.

FIG. 3 is a block chart of the process flow of AV data compression/decompression of the present invention.

FIG. 4 is a block chart of the process flow of the operation of compensation for the decompressed AV data of the present invention.

FIG. 5 is a schematic view of an operation picture taken from Windows Messenger.

FIG. 6 is a schematic view showing a real-time communication operation picture of Yahoo.

FIG. 7 is a schematic view showing an operation picture of the present invention.

FIG. 8 is a schematic view showing a full-screen display of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

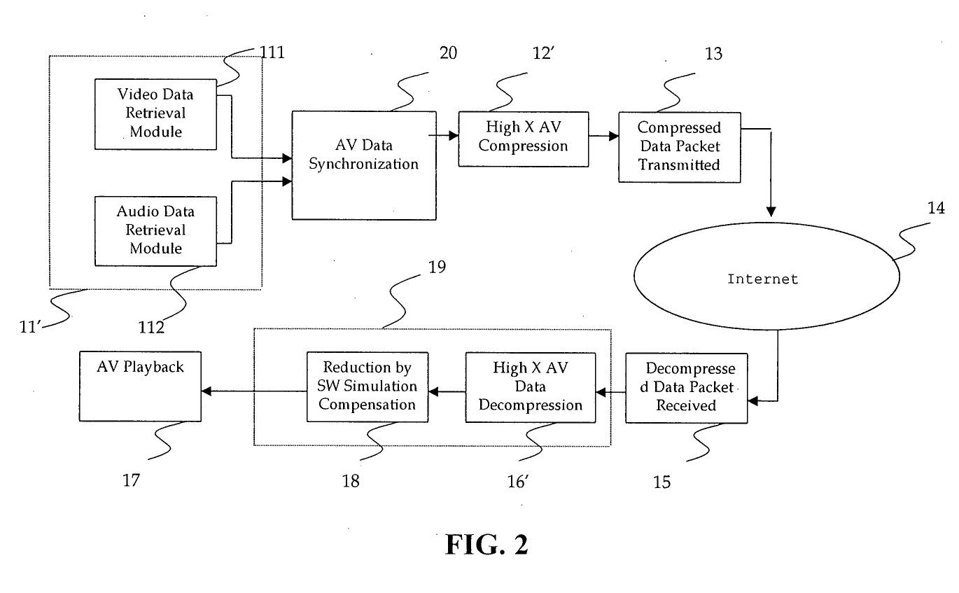

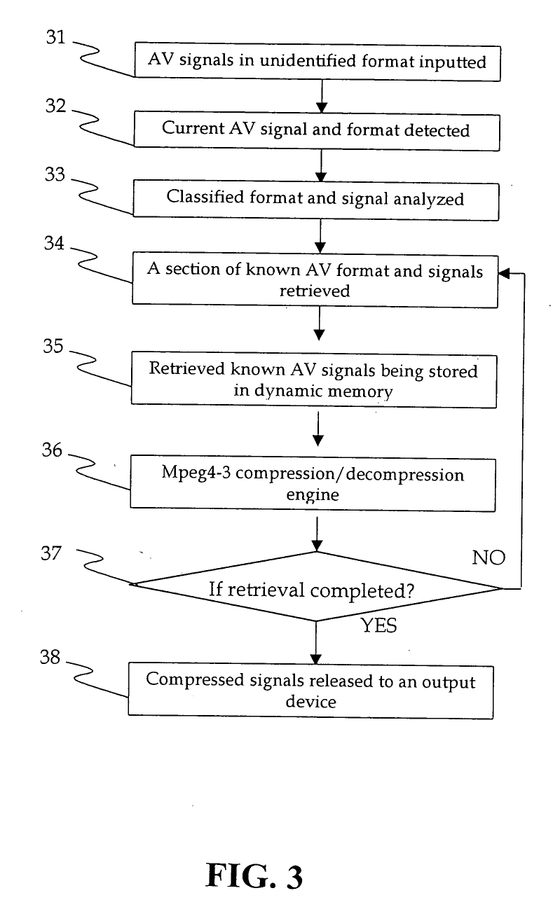

Referring to FIG. 2 for a process flow of the present invention, it is essentially comprised of a video data adaptability retrieval means (11′), an AV data synchronous process means (20), a high multiple AV data compression means (12′), a means to transmit compressed data packet (13), the Internet (14), a means to receive the compressed data packet (15), an AV data decompression/ compensation means (10) and an AV playback means (17). Wherein, the AV data decompression/compensation means (19) further includes a high multiple AV data decompression means (16′) and a reduction means of SW simulation compensation (18). The video data adaptability retrieval means (11′) relates to a PC CAMARA including a module (111) to retrieve video data and another module (112) to retrieve audio data. For the module (111) to retrieve video data, the network bandwidth currently available determines the number of pages the image should be retrieved by second. Generally, 2˜6 pages of image data must be retrieved per second to maintain smooth flow of the video data. As for the module (112) to retrieve audio data, the sound part of the video data is retrieved, and the silent part (i.e., absence of speech from either end) is filtered and registered in a dedicated segment before the CPU in the AV data synchronous process means (20) takes over to synchronize both video and audio data. Meanwhile, the segment where the silent part is registered serves the reference in the synchronization of audio and video data. Accordingly, a user from one end of the network retrieves with a PC CAMARA the original AV data, the data is further and immediately retrieved by both modules (111, 112), then synchronized through the AV data synchronous process means 20 before being decompressed by the high multiple AV compression means (12) in a flow as illustrated in FIG. 3. 1:400 compression ratio is applied using Mpeg4-3 image compression technology to compress the original AV data in the following steps:

Step 31: video signals in unidentified format retrieved by PC CAMARA are inputted.

Step 32: CPU detects AV signals and formats currently inputted.

Step 33: Classified formats and signals are analyzed.

Step 34: Identified AV formats and signals are retrieved.

Step 35: Store the retrieved AV signals identified into dynamic memory.

Step 36: Mpeg4-3 image compression/decompression engine delivered to have its CPC to compress AV signals identified.

Step 37: Judge whether the retrieval is completed and if go to next step is required; if not, return to Step 34.

Step 38: Release the compressed signals to an output device, in this case, the means to transmit the compressed data packet (13) to deliver the compressed data packet into Internet 14. Since the data packet has been compressed to a size 1/400 of that of the original one, the least bandwidth (approximately 20K˜30K) is sufficient for the transmission.

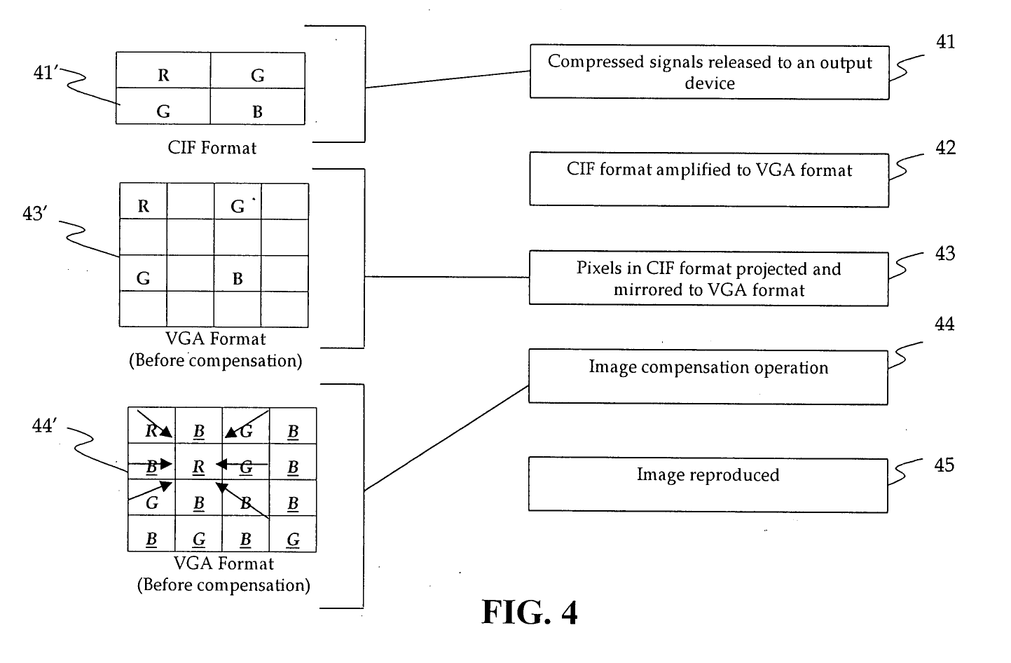

Another user on the other end of the network acquires the compressed AV data from Internet (14) with the means to receive the compressed data packet (15). Then the means to decompress data (16′) is used to decompress the retrieved AV signals identified in a flow as illustrated in FIG. 3. In Step 36, the Mpeg4-3 image compression/decompression engine is applied to decompress, not to compress the AV signals identified. Soonest upon the decompression, the reduction means of SW simulation compensation (19) compensates the distortions including snow, square, and interference (resulted in the process of compression (12′)) for picture reduced. Finally, the means to play back AV (17) releases the signals to the output device (i.e., Step 38 through an AV playback software). As illustrated in FIG. 4 for the flow of the reduction means of SW simulation compensation, signals decompressed (41) (in a CIF format 41′ as illustrated) are amplified up to VGA format 42 to project pixels in CIF format into that of VGA (43) (related to a VGA format 43′ before compensation as illustrated) to commence the operation of image compensation (44) based on the mode of bilinear method to become the VGA format (44′) after compensation. Images are reproduced in the means to play back AV signals (18). Compensation conditions include (1) point-to-point softening process, (2) color contrast process to rid off improper color difference, (3) decompression hues process, (4) improvement of clearness, and (5) process to rid of interference noise. Accordingly, AV results after reduction are promoted up to approach over 90% of that before compression.

In genera, the number of pixel of the PC CAMARA affects the quality of the picture and that as displayed on the monitor after decompression. That is, a 0.35M CMOS PC CAMARA at its best yields the results of 0.35M pixels. However, the introduction of the reduction technology of SW simulation in the process of decompression and further use of CPU on the mother board to enhance operation rate to compensate the damaged image format and to reduce through CPU operation the picture to display DVD or VCD picture quality in the present invention allow the original 0.35M image to demonstrate the picture quality practically same as that of 1M˜2M pixels at the reception end after the transmission via network.

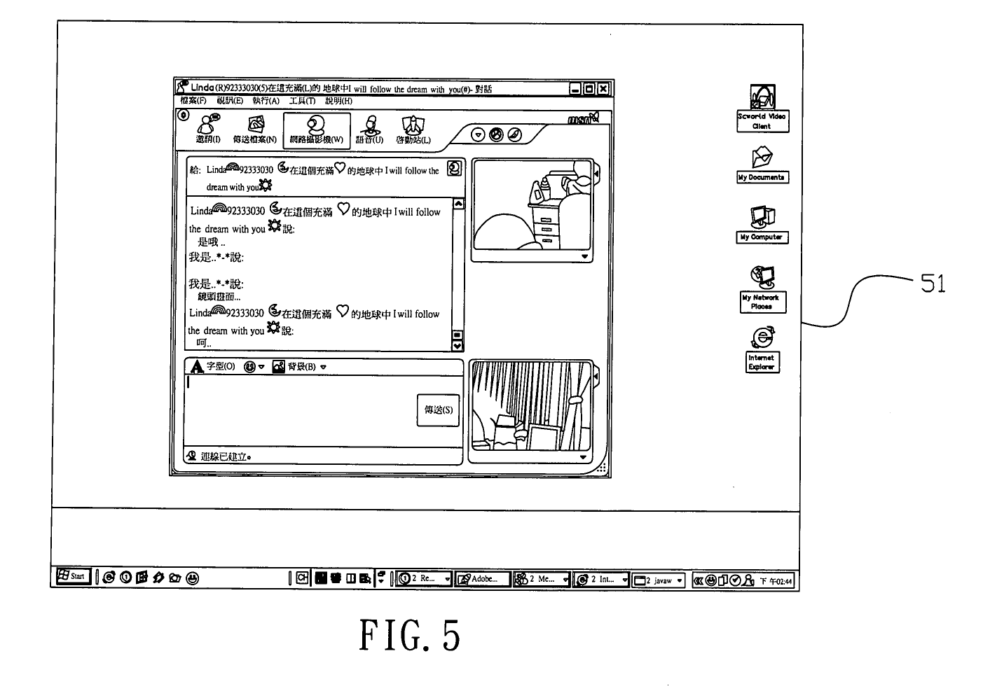

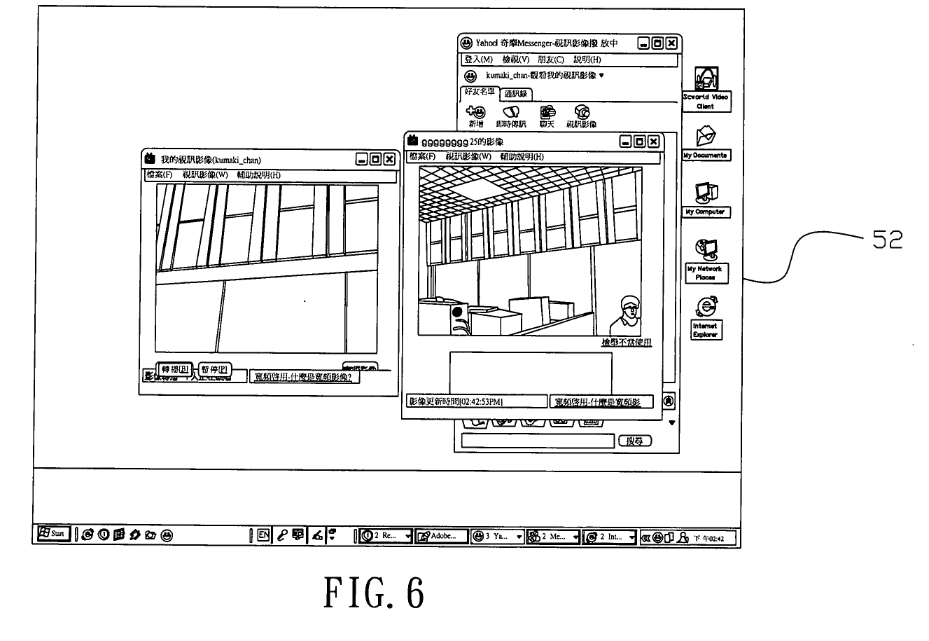

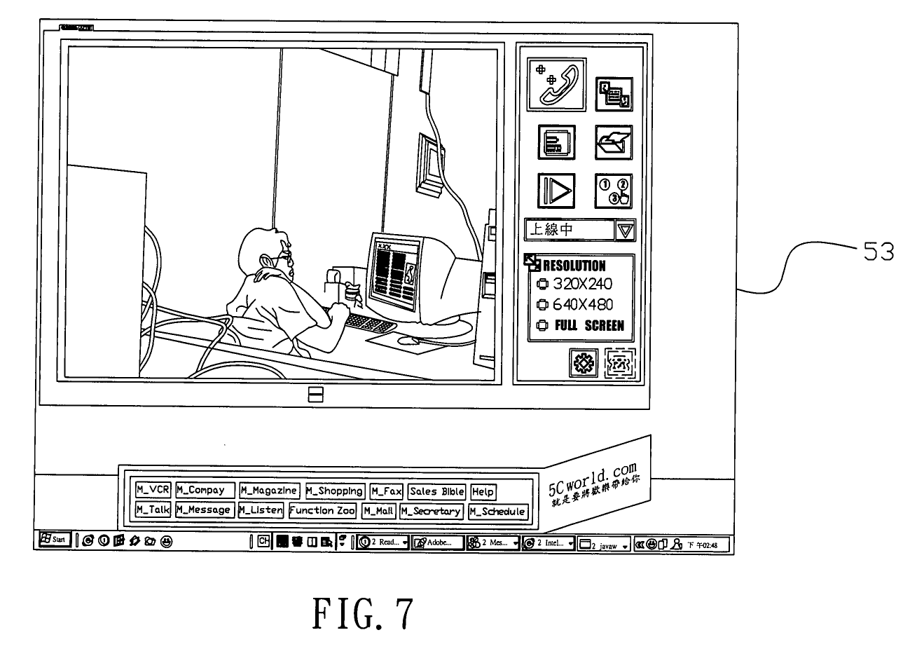

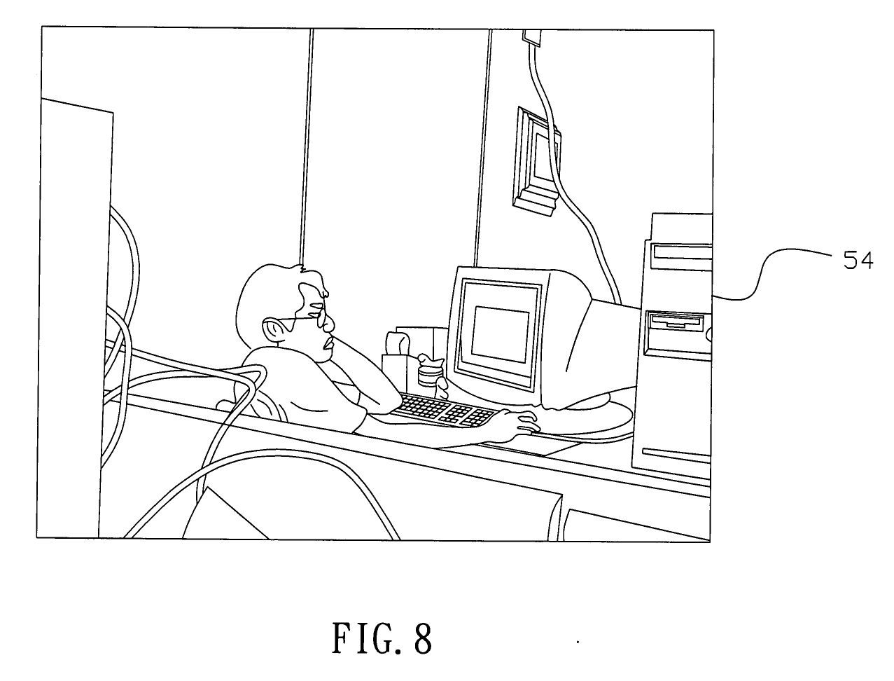

Now referring to FIGS. 5 through 8 for the pictures respectively displayed in Windows Messenger and Yahoo Messenger, the picture (51) relates to a work screen of Windows Messenger showing a size of the picture is as small as that of a stamp; and the picture (52) related to a work screen of Yahoo Messenger permits to be blown up to occupy a quarter of the screen. With the methodology disclosed in the present invention, a picture (53) is displayed in the resolution of 640×480 AS ILLUSTRATED IN FIG. 8, and can be magnified up to the full-screen display (54) as illustrated in FIG. 8 without causing still frame or ambiguity of the picture.

To sum up, the present invention provides the following features:

1. 0.35M pixels of the PC CAMARA (or CCD) are sufficient to achieve the results of a picture with higher end M-pixel quality.

2. The least bandwidth or even the narrow band is sufficient to achieve AV real time communication purpose without increasing the bandwidth.

3. Full-screen AV dialog is possible.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A methodology to improve Internet AV data imaging results and transmission rate is applied within the network configuration of ADSL and modem to conduct full-screen AV dialog including:
a video data adaptability retrieval means using a network camera to take a video data required for full-screen AV dialog with number of pictures to be retrieved per second of image determined by currently available network band width while filtrating and recording fractions of data without voice in the video data;
an AV data synchronous process means to synchronize audio data and voice data in the video data computed with a CPU;
a high multiple AV data compression means to facilitate data transmission in the network by high multiple compression of the video data as computed by the CPU;
an AV data transmission means to transmit the compressed AV data within the configurations of both wide band and narrow band networks; and
an AV data decompression/compensation means to reduce the compressed data though the computation of the CPU to facilitate full-screen real time playback, including a high multiple AV data decompression means and a reduction means of software simulation to compensate the picture observed with image distortions including snow, square, and interference produced in the course of compressing AV data by the CPU.

2. The methodology to improve Internet AV data imaging results and transmission rate of claim 1; wherein, the high multiple AV data compression means relates to Mpeg 4-3 compression technology.

3. The methodology to improve Internet AV data imaging results and transmission rate of claim 1; wherein, the reduction means of software simulation compensation includes a dot-to-dot softening process, a color contrast process, a process to rid of improper color different, a decompression hue process, a process to improve clearness, and a process to rid of interference form noise.

4. The methodology to improve Internet AV data imaging results and transmission rate of claim 1; wherein, the reduction means of software simulation compensation is executed by the operation mode of bilinear method.

5. The methodology to improve Internet AV data imaging results and transmission rate of claim 1; wherein, the video data adaptability retrieval means includes a module for retrieval of video image data with the number of image pages to be retrieved per second to be determined by the band width currently available in the network; and a module for retrieval of the video sound data to retrieve the sound part of the video data, and further to filtrate the silent part in the sound data of the video data.
